(19) United States
(12) Patent Application Publication
(10) Pub. No.: US 2026/0242161 A1
(43) Pub. Date: Aug. 20, 2026

(54) BIN SWEEP SYSTEM FOR MOVING PARTICULATE MATERIAL IN A BIN

(71) Applicant: Sioux Steel Company, Sioux Falls, SD (US)

(72) Inventor: Jesse Horstman, Baltic, SD (US)

(73) Assignee: Sioux Steel Company, Sioux Falls, SD (US)

(21) Appl. No.: 19/460,995

(22) Filed: Jan. 27, 2026

Related U.S. Application Data
(60) Provisional application No. 63/760,503, filed on Feb. 19, 2025.

(51) Int. Cl. B65G 65/48

(52) U.S. Cl. CPC B65G 65/4854

(57) ABSTRACT

A bin sweep system for moving particulate material in a bin includes a housing, a sweep drive assembly, a particulate sweep assembly, and an adjustable coupler. The sweep drive assembly is coupled to the housing. The sweep drive assembly is designed to move the housing. The particulate sweep assembly is mounted on and under the housing. The particulate sweep assembly is designed to move particulate material on the bin floor along the housing toward a sump. The adjustable coupler couples the sweep drive assembly to the housing. The adjustable coupler includes a first coupler member and a second coupler member that are relatively movable to maintain the housing and the particulate sweep assembly in alignment with the bin floor when the housing and the sweep drive assembly are positioned on respective portions of a bin floor surface that are vertically offset.

### CROSS-REFERENCE TO RELATED APPLICATIONS

Applicant claims the benefit under 35 U.S.C. Section 119(e) of U.S. Provisional application 63/760,503, filed Feb. 19, 2025.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to bin sweeps and more particularly pertains to a new bin sweep system designed to compensate for uneven portions of a bin floor surface. Bin sweeps are used to sweep particulate material, such as grain, in a bin. An example of a modular bin sweep system, components of which may be used or adapted for use in an embodiment of the present invention, may be found in U.S. Pat. No. 10,676,294, issued Jun. 9, 2020, which is incorporated by reference herein. The bin floor is typically made of concrete. While a smooth bin floor surface is desired, inherent tolerances in the pouring and smoothing of concrete, as well as unevenness of the ground under the concrete, result in uneven portions of the bin floor surface, such as peaks and valleys or undulations. Such unevenness can result in a housing and a particulate sweep assembly mounted on the housing being tilted or moved out of a desired position with respect to the bin floor. The new bin sweep system includes an adjustable coupler to allow relative movement between a sweep drive assembly and the housing to compensate for the unevenness of the bin floor.

### (2) Description of Related Art Including Information Disclosed under 37 CFR 1.97 and 1.98

The prior art relates to bin sweeps. The prior art, as best understood, does not disclose a bin sweep system for moving particulate material in a bin having a bin floor that includes a housing, a sweep drive assembly, a particulate sweep assembly, and an adjustable coupler to allow relative movement between the sweep drive assembly and the housing to compensate for the unevenness of the bin floor.

### BRIEF SUMMARY OF THE INVENTION

An embodiment of the disclosure meets the needs presented above in a bin sweep system for moving particulate material in a bin having a bin floor generally comprising a housing, a sweep drive assembly, a particulate sweep assembly, and an adjustable coupler. The housing is elongated and has an inboard end and an outboard end. The inboard end is positionable at a central sump of a bin. The sweep drive assembly is coupled to the housing. The sweep drive assembly is designed to move the housing in a circular sweep path along a bin floor about the central sump of the bin. The particulate sweep assembly is mounted on and under the housing. The particulate sweep assembly is designed to move particulate material on the bin floor along the housing toward the inboard end of the housing. The adjustable coupler couples the sweep drive assembly to the housing. The adjustable coupler includes a first coupler member attached to the housing and a second coupler member attached to the sweep drive assembly. The first coupler member and the second coupler member are relatively movable to maintain the housing, the particulate sweep assembly, and the sweep drive assembly in alignment with the bin floor when the housing and the sweep drive assembly are positioned on respective portions of a bin floor surface that are vertically offset.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a sweep drive assembly of a bin sweep system according to an embodiment of the disclosure for use in a bin for containing particulate material, such as grain.

FIG. 2 is a partially exploded perspective view of the sweep drive assembly of an embodiment of the disclosure.

FIG. 3 is a front view of the sweep drive assembly of an embodiment of the disclosure.

FIG. 4 is a side view of the sweep drive assembly of an embodiment of the disclosure.

FIG. 5 is a partially exploded perspective view of the sweep drive assembly of an embodiment of the disclosure.

FIG. 6 is a close-up perspective view of a section of the sweep drive assembly of an embodiment of the disclosure.

FIG. 7 is a side view of a section of the sweep drive assembly of an embodiment of the disclosure.

FIG. 8 is a side view of a section of the sweep drive assembly of an embodiment of the disclosure.

FIG. 9 is a cross-sectional view of an adjustable coupler of the sweep drive assembly in FIG. 8.

FIG. 10 is a cross-sectional view of the adjustable coupler of FIG. 9 in use.

FIG. 11 is a close-up top view of the adjustable coupler.

FIG. 12 is a side view of a bin sweep system of an embodiment of the disclosure.

FIG. 13 is a side view of the bin sweep system of an embodiment of the disclosure.

FIG. 14 is a perspective view of the bin sweep system of an embodiment of the disclosure.

FIG. 15 is a perspective view of a portion of the bin sweep system of an embodiment of the disclosure.

FIG. 16 is a perspective view of a portion of the bin sweep system of an embodiment of the disclosure.

FIG. 17 is a bottom view of a portion of the bin sweep system of an embodiment of the disclosure.

FIG. 18 is a front perspective view of a portion of the bin sweep system of an embodiment of the disclosure.

FIG. 19 is a bottom view of a portion of the bin sweep system of an embodiment of the disclosure.

FIG. 20 is a perspective view of the bin sweep system of an embodiment of the disclosure.

FIG. 21 is a rear view of a portion of the bin sweep system of an embodiment of the disclosure.

### DETAILED DESCRIPTION OF THE INVENTION

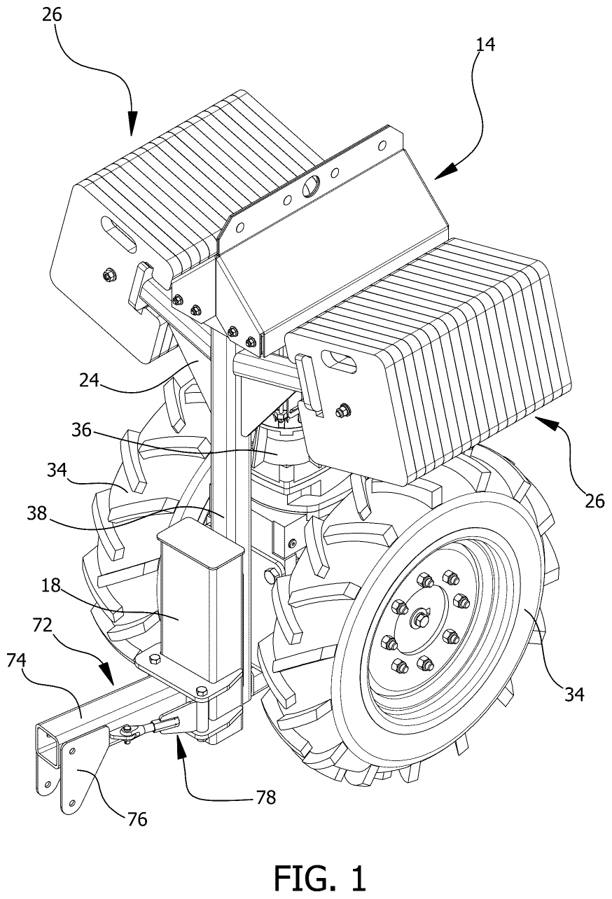

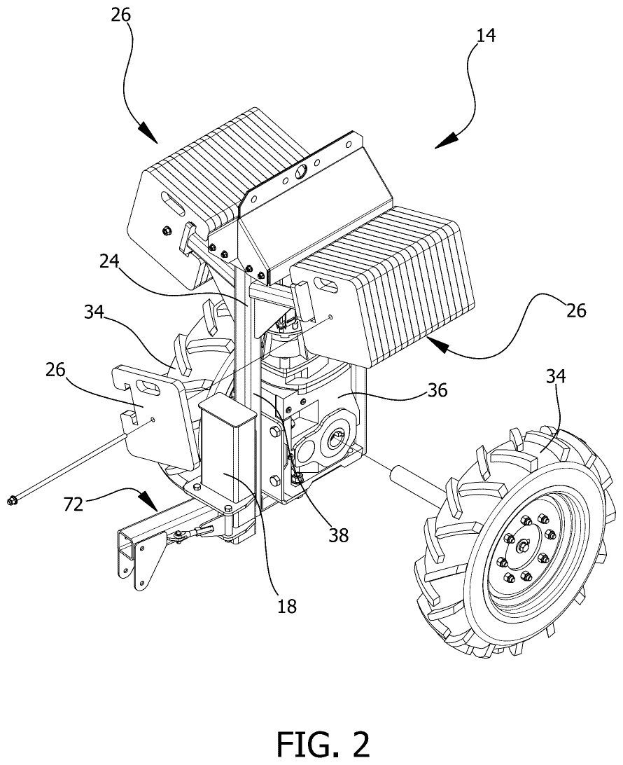

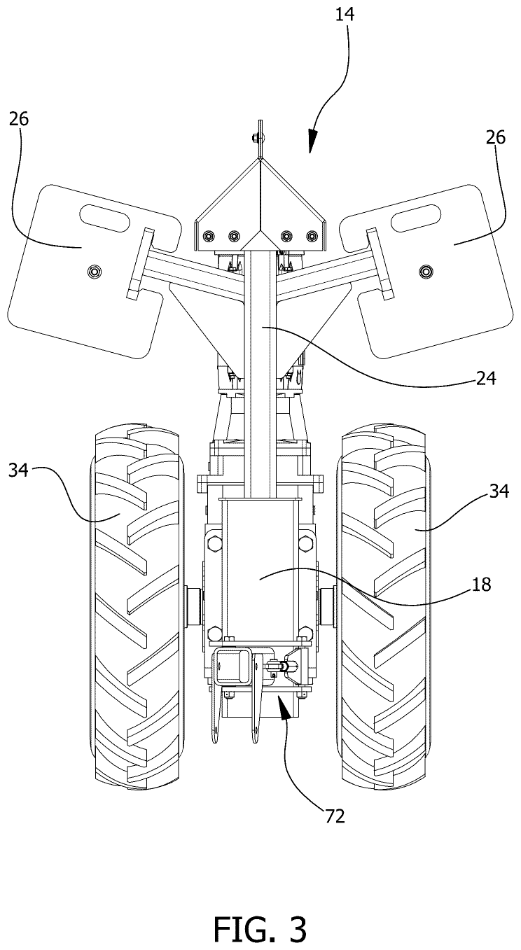

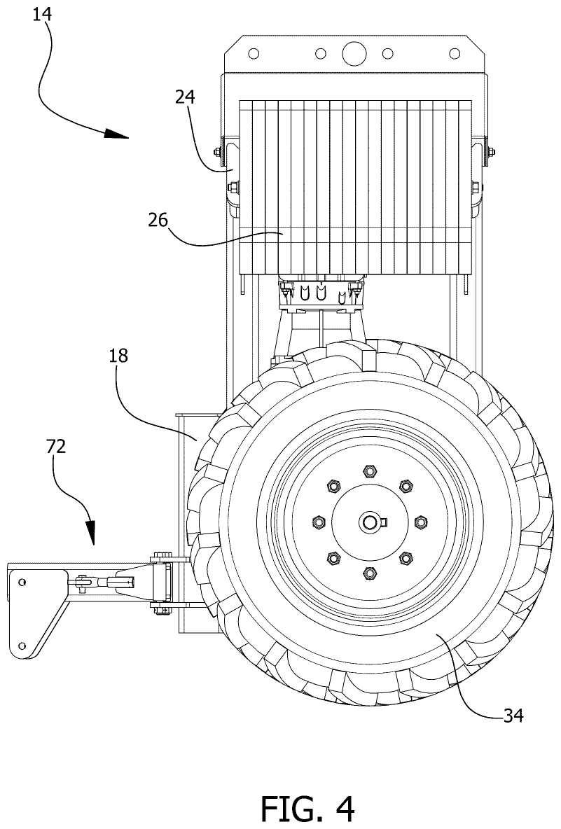

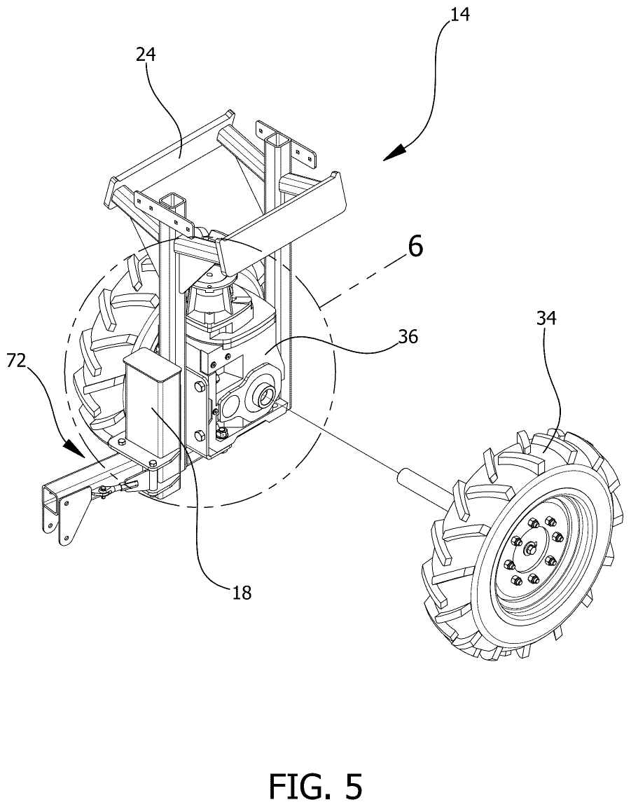

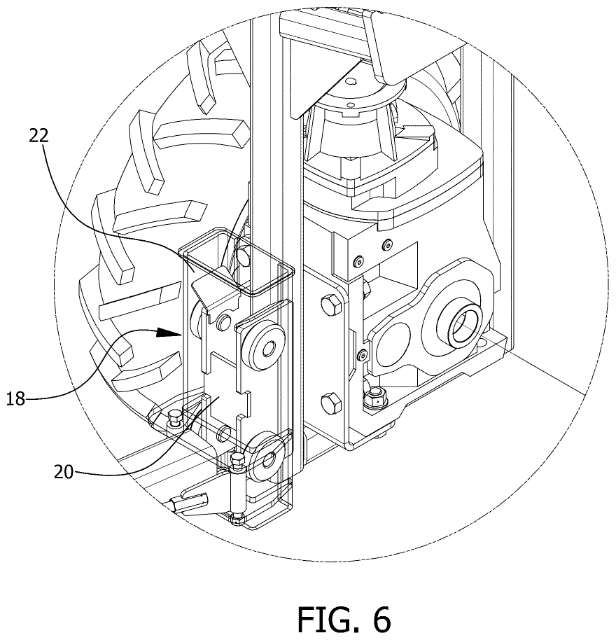

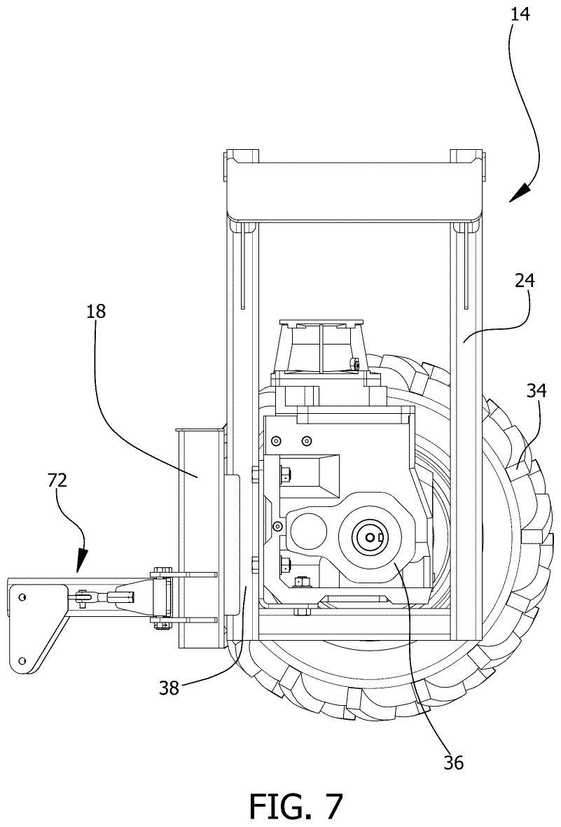

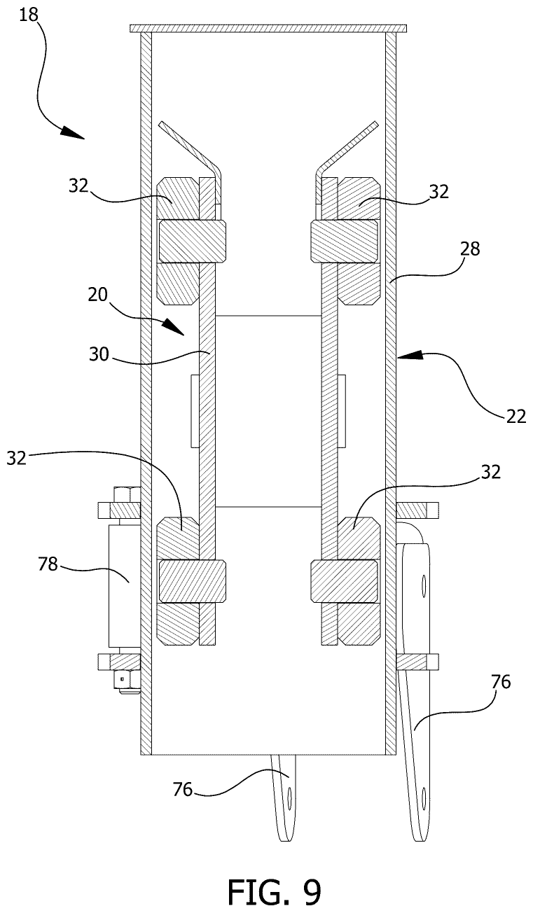

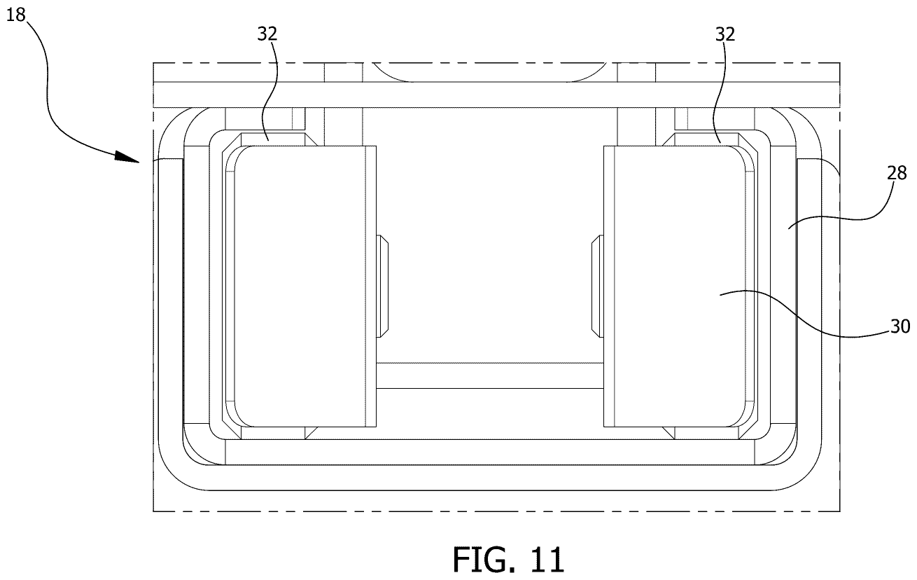

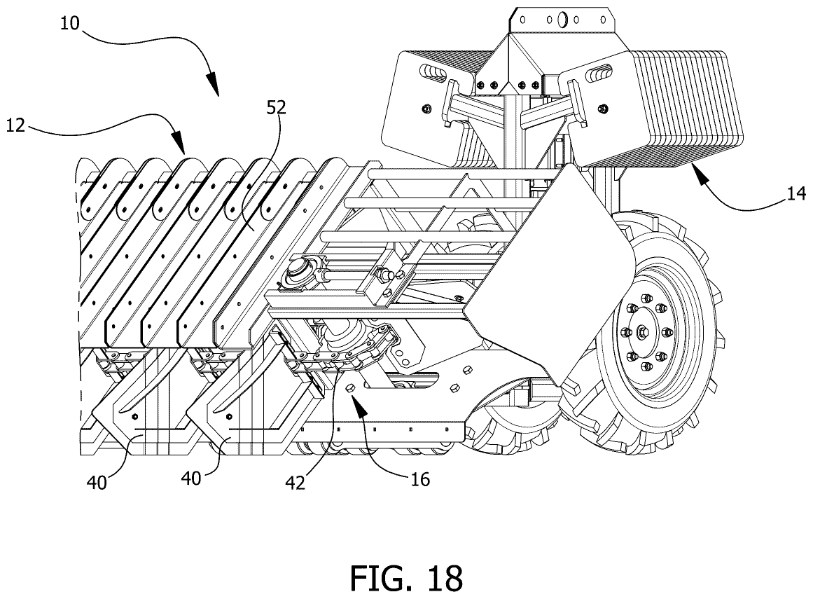

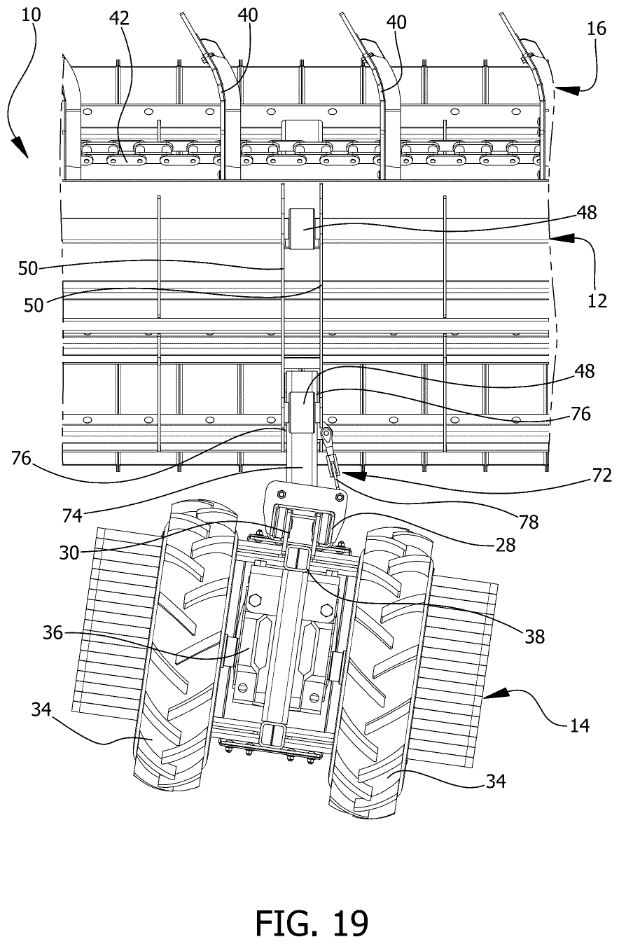

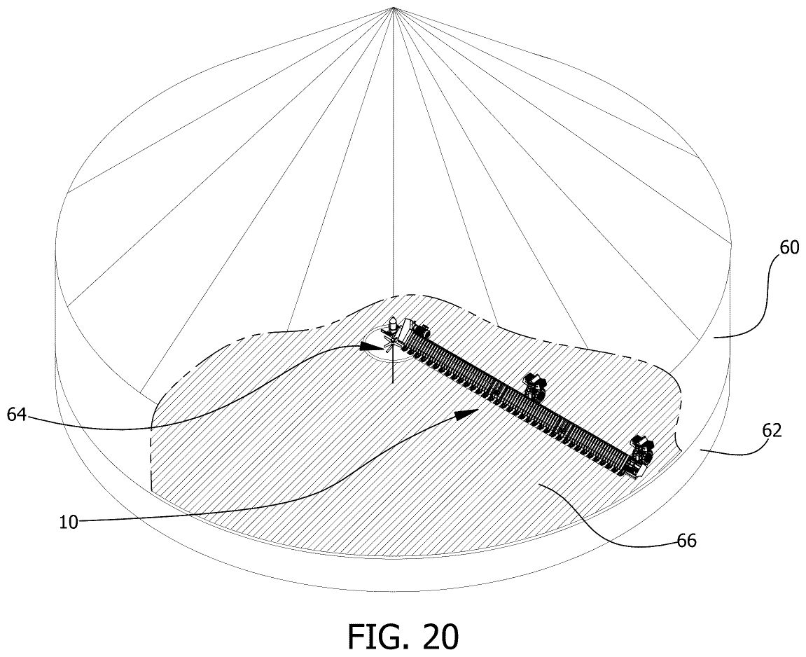

With reference now to the drawings, and in particular to FIGS. 1 through 21 thereof, a new bin sweep system embodying the principles and concepts of an embodiment of the disclosure and generally designated by the reference numeral 10 will be described.

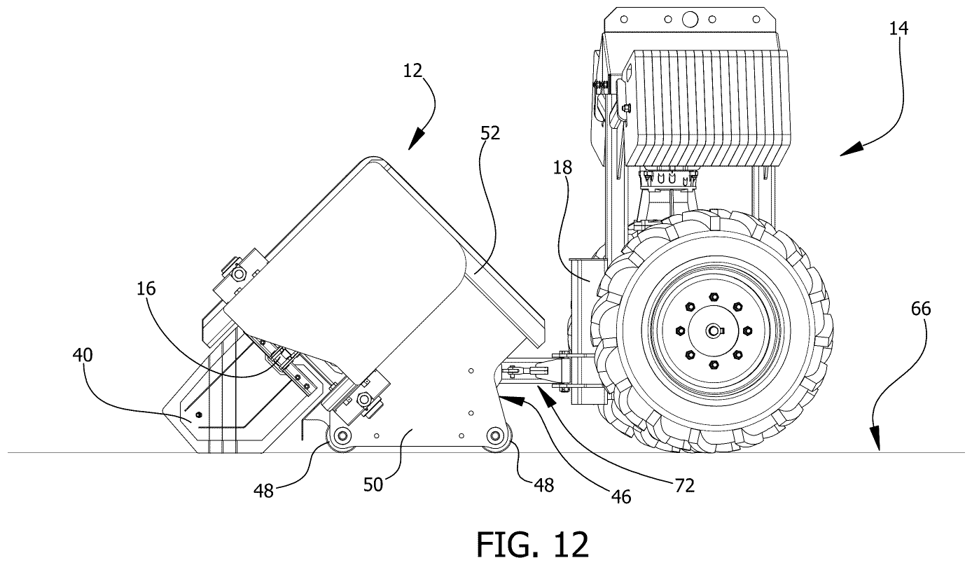

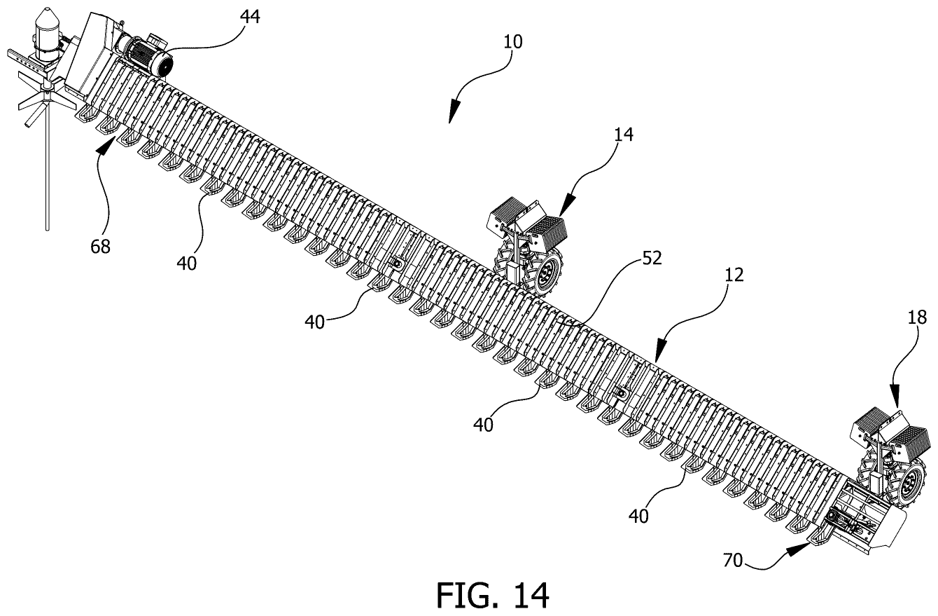

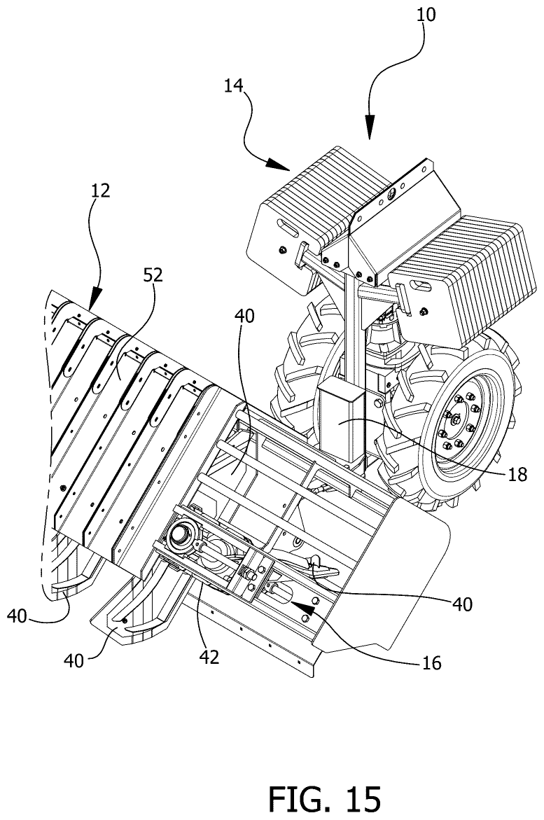

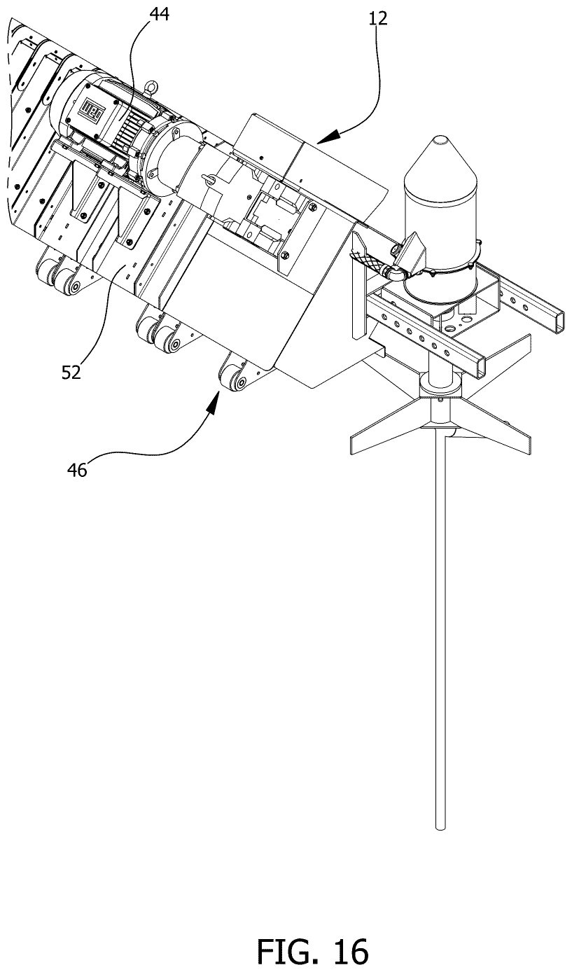

As best illustrated in FIGS. 12 through 21, the bin sweep system 10 for moving particulate material in a bin 60 having a bin floor 62 generally comprises a housing 12, a sweep drive assembly 14, a particulate sweep assembly 16, and an adjustable coupler 18. In the exemplary embodiment in FIG. 14, the housing 12 is elongated and has an inboard end 68, shown in a close up view in FIG. 16, and an outboard end 70, shown in a close up view in FIG. 15. The inboard end 68 is positionable at a central sump 64 of the bin 60. The sweep drive assembly 14 is coupled to the housing 12. The sweep drive assembly 14 is designed to move the housing 12 in a circular sweep path along a bin floor 62 about the central sump 64 of the bin 60. In the exemplary embodiment in FIG. 14, the housing 38 has a modular or sectional design to permit an adjustment of the overall length, and two or more of the sweep drive assemblies 14 could be used as shown, though one may be sufficient in at least one possible embodiment. The particulate sweep assembly 16 is mounted on and under the housing 12. The particulate sweep assembly 16 is designed to move particulate material on the bin floor 62 along the housing 12 toward the inboard end 68 of the housing 12. The adjustable coupler 18 couples the sweep drive assembly 14 to the housing 12. The adjustable coupler 18 includes a first coupler member 20 attached to the housing 12 and a second coupler member 22 attached to the sweep drive assembly 14. The first coupler member 20 and the second coupler member 22 are relatively movable to maintain the housing 12, the particulate sweep assembly 16, and the sweep drive assembly 14 in alignment with the bin floor 62 when the housing 12 and the sweep drive assembly 14 are positioned on respective portions of a bin floor surface 66 that are vertically offset.

In the exemplary embodiment in FIG. 12, the housing 12 is angled. An example of an angled bin sweep, components of which may be used or adapted for use in an embodiment of the present invention, may be found in U.S. Pat. No. 10,442,641, issued Oct. 15, 2019, which is incorporated by reference herein. The angled bin sweep of U.S. Pat. No. 10,442,641 utilizes circulating paddles that are oriented at an angle with respect to the bin floor surface 66 to move the particulate material along the housing 12 toward the sump 64 in the bin floor 62. FIG. 12 shows the housing 12 coupled to the sweep drive assembly 14. One of the paddles 40 of the particulate sweep assembly 16 is visible, which paddle 40 is angled with respect to a bin floor surface 66. It should be understood that the sweep drive assembly 14 could be coupled to different types of housings, and not exclusively an angled bin sweep like the exemplary embodiment shown in the figures. In the exemplary embodiment in FIGS. 14 through 20, the particulate sweep assembly 16 includes an endless loop 42 and a plurality of paddles 40 supported on the endless loop 42. The particulate sweep assembly 16 includes a drive unit 44 coupled to the endless loop 42 to drive the endless loop 42 and move the paddles 40 along a circulating path and sweep particulate material toward the inboard end 68 of the housing 12.

In the exemplary embodiment in FIGS. 1 through 5, the sweep drive assembly 14 includes a drive frame 38, a drive device 36 mounted on the drive frame 38, and a pair of drive wheels 34 mounted on the drive device 36, as is well known in the agricultural arts. Other well-known designs are within the scope of the disclosure. The sweep drive assembly 14 includes a support 24 designed to hold a plurality of weights 26 above the drive wheels 34 and the drive device 36, such that the weights 26 are completely supported on the drive wheels 34. The weights 26 are removable to adjust the total weight.

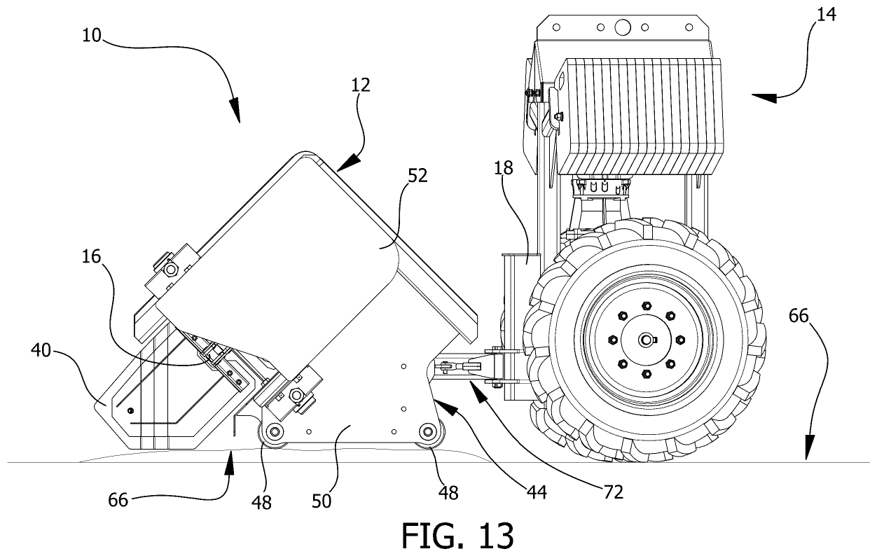

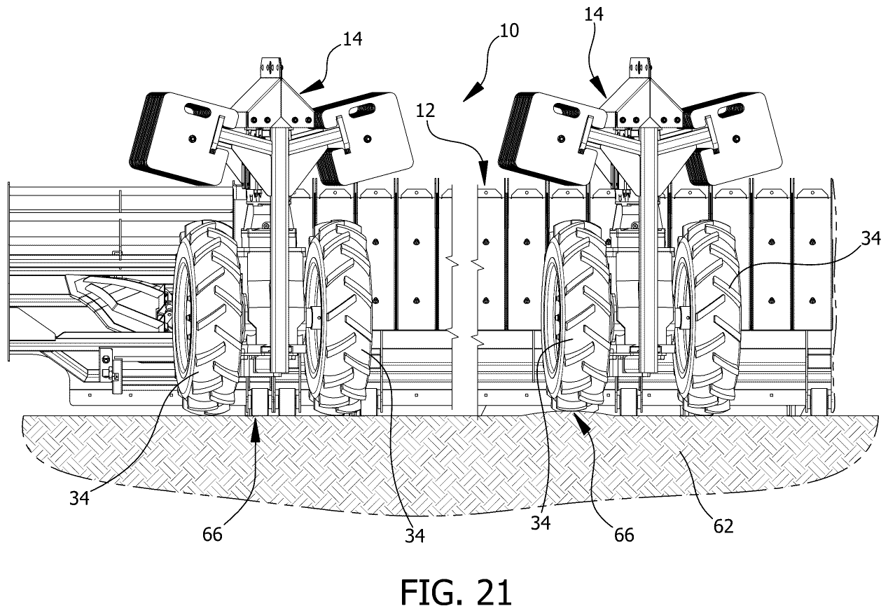

The bin sweep system 10 is used to sweep particulate material, such as, for example, corn grain, wheat grain, or other types of grain, that is stored inside the bin 60. Sumps are located in the bin floor 62 and allow the grain to fall by gravity out through the bin floor 62 and into an augur system, which in turn conducts the grain out of the bin 60, as is well known in the agricultural arts. While some of the grain can fall naturally into the sumps, the rest must be swept toward the sumps by the bin sweep system 10. The bin floor 62 is usually made of concrete. During construction of the bin floor 62, the goal is to make the bin floor surface 66 as smooth as possible, but inherent tolerances during construction result in the bin floor surface 66 having portions that are uneven, that is, there can be peaks and valleys, undulations, bumps, depressions, or high and low spots. In addition, temperature changes and wear and tear can form additional uneven portions of the bin floor surface 66. Such unevenness can result in parts of the bin sweep system 10 being tilted or lifted, which can result in, for example, the housing 12 and the sweep drive assembly 14 being moved out of a desired alignment with the bin floor surface 66, thereby causing incomplete or inaccurate sweeping of the particulate material. For example, if the sweep drive assembly 14 were to be tilted upwardly, particulate material could pass under the sweep drive assembly 14. The adjustable coupler 18 compensates for this unevenness to maintain the housing 12 and the sweep drive assembly 14 in a desired position with respect to the bin floor surface 66. Examples of this compensation are discussed herein and shown in FIGS. 13 and 21.

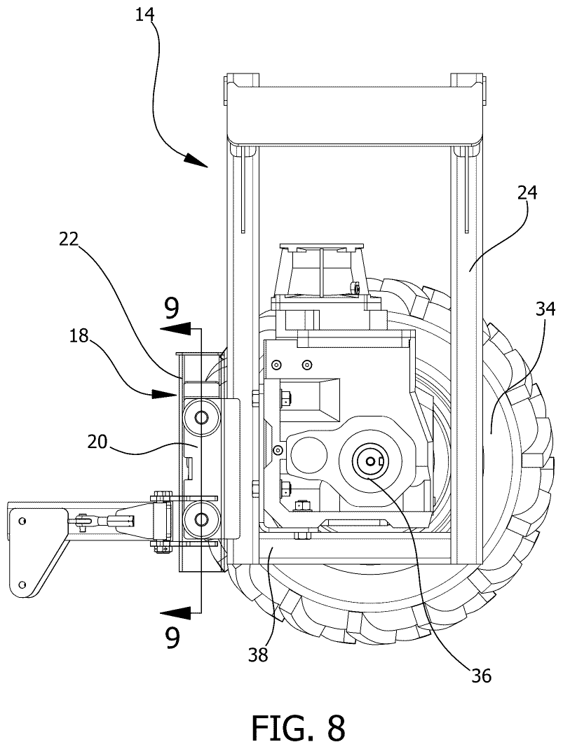

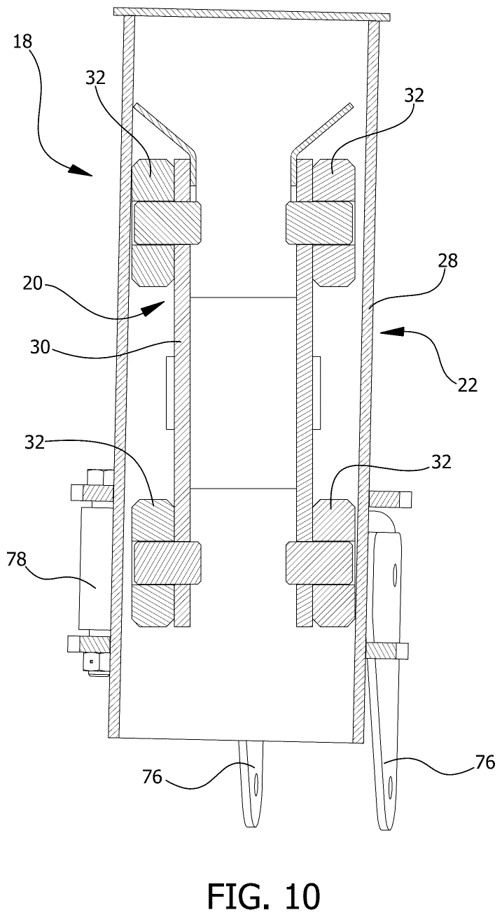

An exemplary embodiment of the adjustable coupler 18 is shown in greater detail in FIGS. 8 through 11. It should be noted that this is only one exemplary embodiment, and modifications and variations of this design are within the scope of the disclosure. The first coupler member 20 is coupled to the sweep drive assembly 14 in a fixed manner such that the first coupler member 20 cannot move vertically or be tilted with respect to the sweep drive assembly 14. The second coupler member 22 is coupled to the housing 12, also in a fixed manner such that the second coupler member 22 cannot move vertically or be tilted with respect to the housing 12. In the exemplary embodiment, the second coupler member 22 includes a sleeve 28. The first coupler member 20 includes a guide frame 30 positioned in the sleeve 28. A plurality of guide wheels 32 are coupled to the guide frame 30. The sleeve 28 and the guide frame 30 are relatively movable for vertical adjustment of the relative positions of the sleeve 28 and the guide frame 30. In addition, an interior width of the sleeve 28 is greater than an exterior width of the guide frame 30 such that there is some space or play between the sleeve 28 and the guide frame 30. This space permits limited relative tilting of the sleeve 28 and the guide frame 30, as shown for example in FIG. 10.

In use, as the bin sweep system 10 moves along the bin floor surface 66, components of the bin sweep system 10 will be positioned on respective portions of the bin floor surface 66 that are vertically offset or uneven. As shown in FIG. 21, for example, one of the drive wheels 34 of the sweep drive assembly 14 may be higher than the other, such that the sweep drive assembly 14 is slightly tilted off the horizontal, or rotated off the vertical, when viewed from the front or rear. In this instance, the first coupler member 20 can tilt relative to the second coupler member 22, such as shown in FIG. 10 for example, such that even though the sweep drive assembly 14 is tilted, the housing 12 is not. In another example, the housing 12 assembly may be higher or lower than the sweep drive assembly 14 due to the unevenness of the bin floor surface 66 creating, in effect, an inclination in the bin floor surface 66. In this instance, the first coupler member 20 and the second coupler member 22 can be relatively moved vertically such that the housing 12 can be vertically offset with respect to the sweep drive assembly 14 without the entire bin sweep system 10 being tilted in an inclined manner with respect to the bin floor surface 66. Such adjustability ensures that the housing 12 and the particulate sweep assembly 16 are maintained in a desired position for sweeping of the particulate material regardless of the unevenness of the bin floor 62. An example is shown in FIG. 13, where each of the housing 12 and the particulate sweep assembly 16 are kept in contact with the bin floor surface 66 despite the unevenness.

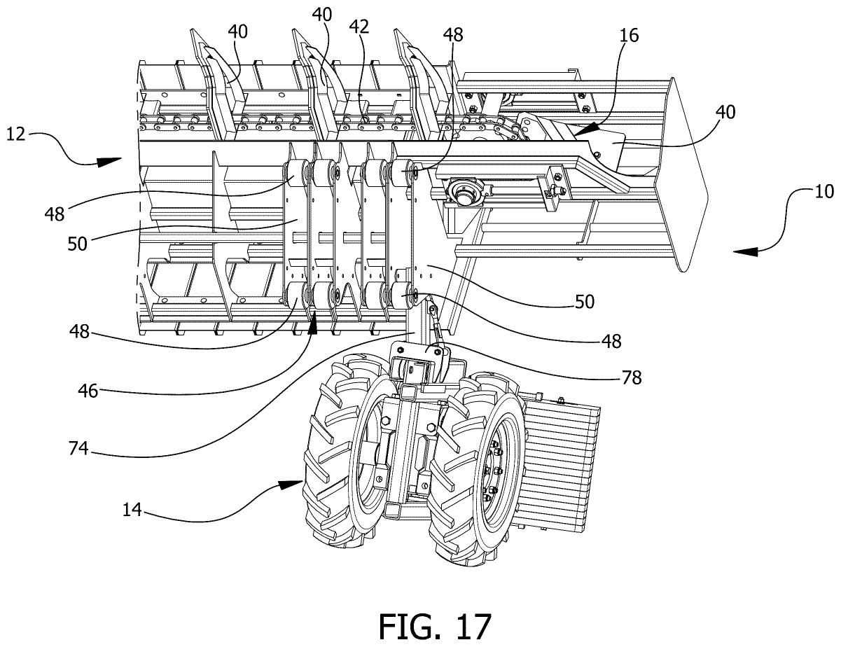

In the exemplary embodiment in FIGS. 17 through 19, the housing 12 includes a support assembly 46 coupled to and under the housing 12. The support assembly 46 includes a plurality of support wheels 48 to movably support the housing 12 on the bin floor 62. The adjustable coupler 18 includes a coupler linkage 72 connecting the support assembly 46 to the sleeve 28.

The support assembly 46 includes a plurality of support plates 50. The support plates 50 are attached to and extend from the housing 12 in a vertical direction toward the bin floor 62. Pairs of the support wheels 48 are rotatably mounted on and between a respective pair of the support plates 50. The coupler linkage 72 includes a linkage arm 74 and a pair of linkage plates 76 attaching the linkage arm 74 to a respective pair of the support plates 50. The coupler linkage 72 includes a pivotable coupler 78 attached to the sleeve 28. The pivotable coupler 78 pivotably connects the linkage arm 74 to the sleeve 28 such that the linkage arm 74 can be adjusted in position with respect to the sleeve 28 for movement of the housing 12 along the circular sweep path.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A bin sweep system for moving particulate material in a bin having a bin floor comprising:
a housing, the housing being elongated and having an inboard end and an outboard end, the inboard end being positionable at a central sump of a bin;
a sweep drive assembly, the sweep drive assembly being coupled to the housing, the sweep drive assembly being configured to move the housing in a circular sweep path along a bin floor about the central sump of the bin;
a particulate sweep assembly, the particulate sweep assembly being mounted on under the housing, the particulate sweep assembly being configured to move particulate material on the bin floor along the housing toward the inboard end of the housing; and
an adjustable coupler, the adjustable coupler coupling the sweep drive assembly to the housing, the adjustable coupler including a first coupler member attached to the housing and a second coupler member attached to the sweep drive assembly, the first coupler member and the second coupler member being relatively movable to maintain the housing, the particulate sweep assembly, and the sweep drive assembly in alignment with the bin floor when the housing and the sweep drive assembly are positioned on respective portions of a bin floor surface that are vertically offset.

2. The bin sweep system of claim 1, wherein:
the second coupler member includes a sleeve;
the first coupler member includes a guide frame; and
the guide frame is positioned in the sleeve and relatively movable with respect to the sleeve for vertical adjustment of the relative positions of the sleeve and the guide frame.

3. The bin sweep system of claim 2, further comprising a support assembly coupled to and under the housing, wherein:
the support assembly includes a plurality of support wheels to movably support the housing on the bin floor; and
the adjustable coupler includes a coupler linkage connecting the support assembly to the sleeve.

4. The bin sweep system of claim 3, wherein:
the support assembly includes a plurality of support plates;
the support plates are attached to and extend from the housing in a vertical direction toward the bin floor;
pairs of the support wheels are rotatably mounted on and between a respective pair of the support plates;
the coupler linkage includes a linkage arm and a pair of linkage plates attaching the linkage arm to a respective pair of the support plates;
the coupler linkage includes a pivotable coupler attached to the sleeve; and
the pivotable coupler pivotably connects the linkage arm to the sleeve such that the linkage arm can be adjusted in position with respect to the sleeve for movement of the housing along the circular sweep path.

5. The bin sweep system of claim 2, wherein:
the sweep drive assembly includes a drive frame, a drive device mounted on the drive frame, and a pair of drive wheels rotatably mounted on the drive device; and
the guide frame of the adjustable coupler is attached to the drive frame.

6. The bin sweep system of claim 2, wherein:
the particulate sweep assembly includes an endless loop and a plurality of paddles supported on the endless loop; and
the particulate sweep assembly includes a drive unit coupled to the endless loop to drive the endless loop and move the paddles along a circulating path and sweep particulate material toward the inboard end of the housing.

7. The bin sweep system of claim 2, further comprising a plurality of guide wheels, the guide wheels being coupled to the guide frame for rolling movement of the guide frame with respect to the sleeve.

8. The bin sweep system of claim 7, wherein:
the sleeve has an interior width and the guide frame has an exterior width; and
the interior width of the sleeve is greater than the exterior width of the guide frame such that there is space between the sleeve and the guide frame for limited relative tilting of the sleeve and the guide frame with respect to each other.

9. The bin sweep system of claim 8, further comprising a support assembly coupled to and under the housing, wherein:
the support assembly includes a plurality of support wheels to movably support the housing on the bin floor; and
the adjustable coupler includes a coupler linkage connecting the support assembly to the sleeve.

10. The bin sweep system of claim 9, wherein:
the support assembly includes a plurality of support plates;
the support plates are attached to and extend from the housing in a vertical direction toward the bin floor;
pairs of the support wheels are rotatably mounted on and between a respective pair of the support plates;
the coupler linkage includes a linkage arm and a pair of linkage plates attaching the linkage arm to a respective pair of the support plates;
the coupler linkage includes a pivotable coupler attached to the sleeve; and
the pivotable coupler pivotably connects the linkage arm to the sleeve such that the linkage arm can be adjusted in position with respect to the sleeve for movement of the housing along the circular sweep path.

11. The bin sweep system of claim 10, wherein:
the sweep drive assembly includes a drive frame, a drive device mounted on the drive frame, and a pair of drive wheels rotatably mounted on the drive device; and
the guide frame of the adjustable coupler is attached to the drive frame.

12. The bin sweep system of claim 11, wherein:
the particulate sweep assembly includes an endless loop and a plurality of paddles supported on the endless loop; and
the particulate sweep assembly includes a drive unit coupled to the endless loop to drive the endless loop and move the paddles along a circulating path and sweep particulate material toward the inboard end of the housing.

13. A sweep assembly for moving particulate material in a bin having a bin floor comprising:
a housing;
a particulate sweep assembly, the particulate sweep assembly being mounted on the housing under the housing, the particulate sweep assembly being configured to move particulate material on the bin floor along the housing toward an inboard end of the housing; and
an adjustable coupler, the adjustable coupler being configured to couple the housing to a sweep drive assembly configured to move the housing in a circular sweep path along a bin floor about a central sump of a bin, the adjustable coupler including a first coupler member attached to the housing and a second coupler member being configured to be attached to the sweep drive assembly, the first coupler member and the second coupler member being relatively movable to maintain the housing, the particulate sweep assembly, and the sweep drive assembly in alignment with the bin floor when the housing and the sweep drive assembly are positioned on respective portions of a bin floor surface that are vertically offset.

14. The sweep assembly of claim 13, wherein:
the second coupler member includes a sleeve;
the first coupler member includes a guide frame;
the guide frame is positioned in the sleeve and relatively movable with respect to the sleeve for vertical adjustment of the relative positions of the sleeve and the guide frame;

15. The sweep assembly of claim 14, wherein:
the sleeve has an interior width and the guide frame has an exterior width; and
the interior width of the sleeve is greater than the exterior width of the guide frame such that there is space between the sleeve and the guide frame for limited relative tilting of the sleeve and the guide frame with respect to each other.

16. The sweep assembly of claim 15, further comprising a support assembly coupled to and under the housing, wherein:
the support assembly includes a plurality of support wheels to movably support the housing on the bin floor; and
the adjustable coupler includes a coupler linkage connecting the support assembly to the sleeve;

17. The sweep assembly of claim 16, wherein:
the support assembly includes a plurality of support plates;
the support plates are attached to and extend from the housing in a vertical direction toward the bin floor;
pairs of the support wheels are rotatably mounted on and between a respective pair of the support plates;
the coupler linkage includes a linkage arm and a pair of linkage plates attaching the linkage arm to a respective pair of the support plates;
the coupler linkage includes a pivotable coupler attached to the sleeve;
the pivotable coupler pivotably connects the linkage arm to the sleeve such that the linkage arm can be adjusted in position with respect to the sleeve for movement of the housing along the circular sweep path;
the sweep drive assembly includes a drive frame, a drive device mounted on the drive frame, and a pair of drive wheels rotatably mounted on the drive device;
the guide frame of the adjustable coupler is attached to the drive frame;
the particulate sweep assembly includes an endless loop and a plurality of paddles supported on the endless loop; and
the particulate sweep assembly includes a drive unit coupled to the endless loop to drive the endless loop and move the paddles along a circulating path and sweep particulate material toward the inboard end of the housing.

18. A sweep drive assembly for moving a housing in a circular sweep path along a bin floor about a central sump of a bin comprising:
a drive frame;
a drive device, the drive device being mounted on the drive frame;
a pair of drive wheels, the drive wheels being coupled to the drive device; and
an adjustable coupler, the adjustable coupler being configured to couple the sweep drive assembly to a housing, the adjustable coupler including a first coupler member being configured to be attached to the housing and a second coupler member being attached to the sweep drive assembly, the first coupler member and the second coupler member being relatively movable to maintain the housing and the sweep drive assembly in alignment with the bin floor when the housing and the sweep drive assembly are positioned on respective portions of a bin floor surface that are vertically offset.

19. The sweep drive assembly of claim 18, wherein:
the second coupler member includes a sleeve;
the first coupler member includes a guide frame; and
the guide frame is positioned in the sleeve and relatively movable with respect to the sleeve for vertical adjustment of the relative positions of the sleeve and the guide frame.

20. The sweep drive assembly of claim 19, wherein:
the guide frame of the adjustable coupler is attached to the drive frame;
the sleeve has an interior width and the guide frame has an exterior width;
the interior width of the sleeve is greater than the exterior width of the guide frame such that there is space between the sleeve and the guide frame for limited relative tilting of the sleeve and the guide frame with respect to each other;
the adjustable coupler includes a coupler linkage being configured to connect the sleeve to the housing;
the coupler linkage includes a linkage arm and a pair of linkage plates attaching the linkage arm to the housing;
the coupler linkage includes a pivotable coupler attached to the sleeve; and
the pivotable coupler pivotably connects the linkage arm to the sleeve such that the linkage arm can be adjusted in position with respect to the sleeve for movement of the housing along a circular sweep path.
